(19) United States
(12) Patent Application Publication
(10) Pub. No.: US 2002/0096490 A1
(43) Pub. Date: Jul. 25, 2002

(54) Photolithographic and etching method

(76) Inventor: Chia-Chieh Yu, Taipei Hsien (TW)

Correspondence Address: CHARLES C.H. WU & ASSOCIATES, Suite 710, 7700 IRVINE CENTER DRIVE, Irvine, CA, 92618-3043, US

(21) Appl. No.: 09/776,346

(22) Filed: Feb. 2, 2001

(30) Foreign Application Priority Data
Jan. 20, 2001 (TW) 90101424

(51) Int. Cl. B44C 1/22; C03C 15/00; C23F 1/00

(52) U.S. Cl. 216/41

(57) ABSTRACT

A photolithographic and etching method. A substrate having a conductive layer thereon is provided. A first mask layer and a second mask layer are sequentially formed over the conductive layer. A patterned photoresist layer is formed over the substrate. Using the photoresist layer as a mask, a portion of the second mask layer is removed to form a second mask layer having a narrow-top/wide-bottom profile over the first mask layer. Using the second mask layer as a mask, a portion of the first mask layer is removed. The photoresist layer is removed. Using the first mask layer as a mask, the second mask layer and a portion of the conductive layer is removed to form a conductive pattern over the substrate. Finally, the first mask layer is removed.

### CROSS-REFERENCE TO RELATED APPLICATION

This application claims the priority benefit of Taiwan application serial no. 90101424, filed Jan. 20, 2001.

### BACKGROUND OF THE INVENTION

1. Field of Invention

The present invention relates to a photolithographic and etching method. More particularly, the present invention relates to a photolithographic and etching method that can have a wider pattern line width but a smaller pattern line separation.

2. Description of Related Art

Photolithography is one of the most important processes in the fabrication of semiconductor devices. Many processes that relate to the fabrication of a MOS device such as thin film patterning or dopant implantation involve photolithographic processes.

As the level of integration of integrated circuit increases, size of each semiconductor device shrinks correspondingly. Consequently, photolithographic processes are becoming difficult to conduct. Ideally, width of conductive line in an integrated circuit should be as wide as possible while distance of separation between neighboring lines should be as close together as possible. However, due to some constraints in photolithographic exposure, critical dimension (CD) on a photoresist layer can hardly keep up with design requirement.

In general, spacers can be used to increase the width of conductive line pattern and reduce separation between conductive lines. FIGS. 1A through 1C are schematic cross-sectional views showing the progression of steps for forming conventional conductive lines over a substrate. As shown in FIG. 1A, a substrate 100 having a polysilicon layer 102 thereon is provided. Silicon nitride is deposited over the polysilicon layer 102 to form a silicon nitride layer (not shown). A patterned photoresist layer (not shown) is formed over the silicon nitride layer. Using the patterned photoresist layer as a mask, an anisotropic etching of the silicon nitride layer is conducted to form an etching mask 104. The etching mask 104 has a width that reflects the capacity of pattern production after photo-exposure. Therefore, width of the etching mask 104 is narrower than the desired conductive line pattern.

As shown in FIG. 1B, silicon nitride is again deposited over the substrate 100 to form a silicon nitride layer (not shown). The silicon nitride layer is etched back to form spacers 106 on the sidewalls of the etching mask 104. Through the formation of spacers 106, width of the etching mask 104 is increased so that an etching mask 108 having the desired conductive line width is formed.

As shown in FIG. 1C, using the etching mask 108 as a mask, an anisotropic etching of the conductive layer 102 is carried out. Ultimately, conductive lines 110 having a greater width but a smaller separation 112 between conductive lines on the substrate 100 are formed.

The aforementioned process of forming spacers on the sidewalls of etching mask to reduce separation between conductive lines has the following disadvantages:

1. To form spacers on the sidewalls of the etching mask, the photoresist layer above the etching mask must first be removed by etching. Subsequently, the silicon wafer has to be taken out from the etching chamber and transferred to a deposition chamber so that a layer of silicon nitride can be deposited over the substrate. Thereafter, the wafer is returned into the etching chamber so that the deposited silicon nitride layer is etched back to form the spacers. The shuttling of the wafer between the etching chamber and the deposition chamber is quite troublesome and often leads to unwanted complications; and

2. Sometimes, the polysilicon layer may have a great step height. When this is the case, the process of etching back the silicon nitride layer to form spacers may produce residual spacers on the junction between the height transition region of the polysilicon layer. The residual spacers prevent the removal of some of the conductive material. Ultimately, after the spacers are removed, the residual conductive material may lead to bridging between devices. Consequently, undesirable electrical connection or short-circuiting may occur between devices.

### SUMMARY OF THE INVENTION

Accordingly, one object of the present invention is to provide a photolithographic and etching method capable of forming a conductive layer having a larger critical dimension in-situ and thus simplifying the fabrication process.

A second object of the invention is to provide a method of forming shallow trench isolation structure capable of forming a conductive layer having larger critical dimension over a device with great step height.

To achieve these and other advantages and in accordance with the purpose of the invention, as embodied and broadly described herein, the invention provides a photolithographic and etching method. A substrate having a conductive layer thereon is provided. A first mask layer and a second mask layer are sequentially formed over the conductive layer. A patterned photoresist layer is formed over the substrate. Using the photoresist layer as a mask, a portion of the second mask layer is removed to form a second mask layer having a narrow-top/wide-bottom profile over the first mask layer. Using the second mask layer as a mask, a portion of the first mask layer is removed. The photoresist layer is removed. Using the first mask layer as a mask, the second mask layer and a portion of the conductive layer is removed to form a conductive pattern over the substrate. Finally, the first mask layer is removed.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIGS. 1A through 1C are schematic cross-sectional views showing the progression of steps for forming conventional conductive lines over a substrate; and

FIGS. 2A through 2E are schematic cross-sectional view showing the progression of steps for forming conductive lines over a substrate using a photolithographic and etching method according to one preferred embodiment of this invention.

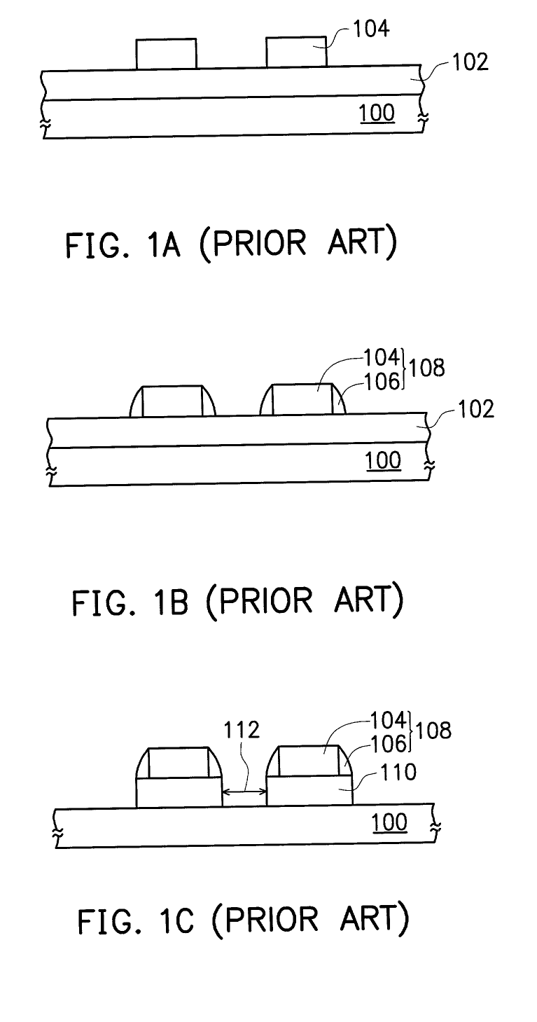

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

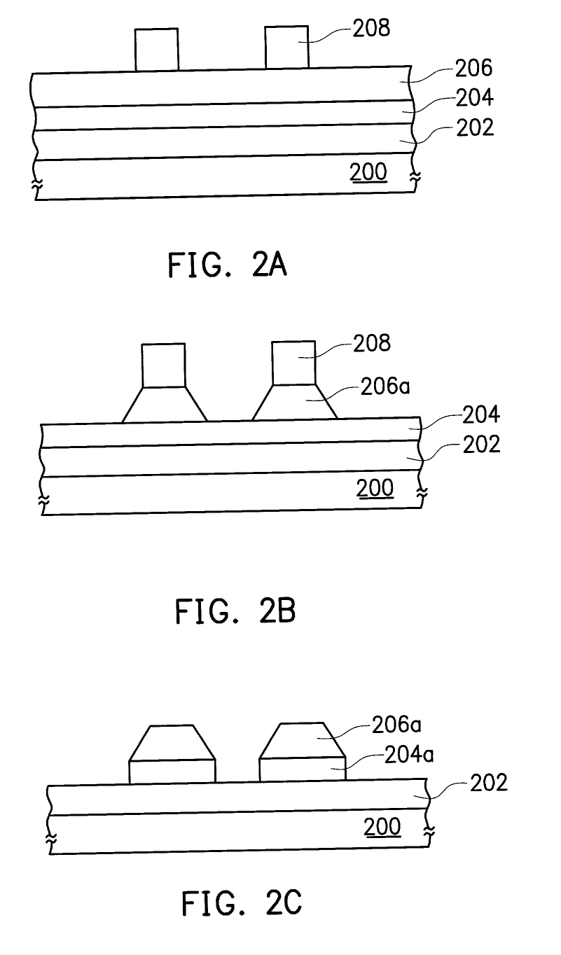

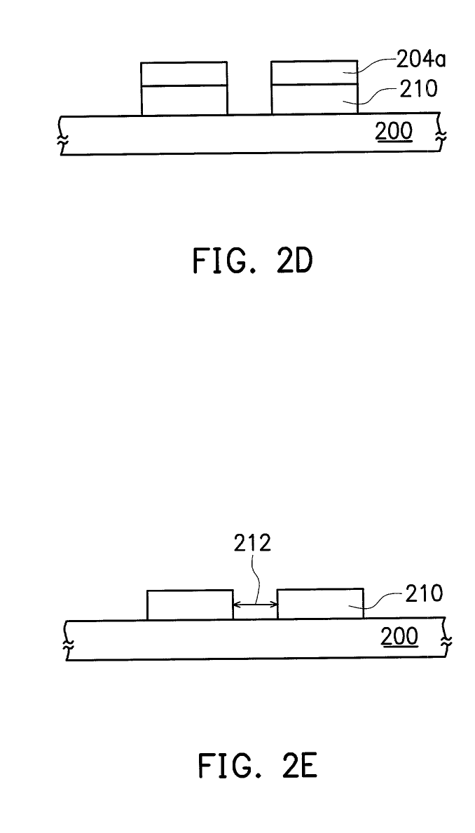

FIGS. 2A through 2E are schematic cross-sectional view showing the progression of steps for forming conductive lines over a substrate using a photolithographic and etching method according to one preferred embodiment of this invention.

As shown in FIG. 2A, a substrate 200 is provided. A conductive layer 202, a first mask layer 204 and a second mask layer 206 are sequentially formed over the substrate 200. The conductive layer 202, the first mask layer 204 and the second mask layer 206 are formed, for example, by chemical vapor deposition. The conductive layer 202 can be a polysilicon layer, the first mask layer 204 can be a silicon nitride layer and the second mask layer 206 can be a polysilicon layer, for example. A patterned photoresist layer 208 is formed over the second mask layer 206. Due to limitations in photo-exposure, width of the photoresist layer 208 is narrower than the desired pattern line width of the conductive layer 202. Moreover, separation of patterned lines in the photoresist layer 208 is greater than the intended separation of conductive lines in the conductive layer 202.

As shown in FIG. 2B, using the photoresist layer 208 as a mask, the second mask layer 206 is etched to form a second mask layer 206a having a narrow-top/wide-bottom profile over the first mask layer 204. The trapezium-shaped second mask layer 206a is formed by performing a slant anisotropic etching to remove a portion of the second mask layer 206 and expose the upper surface of the first mask layer 204. The gaseous etchant used in the slant anisotropic etching includes carbon. Since the second mask layer 206a is a polysilicon layer, carbon content of the gaseous etchant is often raised so that a layer of high molecular weight polymer is deposited on the second mask layer 206. Ultimately, a trapezium-shaped second mask layer 206a that satisfies the required conductive line width is formed. In addition, a distance of separation between the second mask layers 206a smaller than the critical dimension reproducible by the photoresist layer is also formed.

As shown in FIG. 2C, using the second mask layer 206a as a mask, a portion of the first mask layer 204 is removed by anisotropic etching to form a mask layer 204a and expose the conductive layer 202. The photoresist layer 208 above the second mask layer 206a is removed. Since the second mask layer 206a has already defined position and width of the conductive line pattern, the second mask layer 206a and the first mask layer 204a has identical transfer pattern.

As shown in FIG. 2D, using the first mask layer 204a as a mask, conductive line pattern 210 is formed over the substrate 200. The conductive line pattern 210 is formed, for example, by performing anisotropic etching to remove the second mask layer 206a and a portion of the conductive layer 202 and expose a portion of the substrate 200. Since the second mask layer 206a is a polysilicon layer, the process of removing a portion of the conductive layer 202 to form the conductive line pattern 210 is capable of removing the second mask layer 206a. Furthermore, the steps shown in FIGS. 2B and 2D can be conducted in the same reaction chamber of an etching station. The transfer of wafer from an etching chamber to a deposition chamber for depositing silicon nitride and then back to the etching chamber again for subsequent etching are not required. Hence, the process of fabricating the conductive line pattern 210 is very much simplified.

Finally, as shown in FIG. 2E, the first mask layer 204a above the conductive line pattern 210 is removed. The first mask layer 204a is removed, for example, using hot phosphoric acid in a wet etching operation. Therefore, aside from producing a conductive line pattern having a greater line width over the substrate 200, distance of separation 212 between neighboring conductive lines in the conductive line pattern 210 are closer together.

One major aspect of this invention is the formation of a second mask layer over the first mask layer. By performing a slant anisotropic etching, width and position of line pattern in the second mask layer can be more precisely controlled to form a narrowtop/wide-bottom profile. Hence, a conductive line pattern having a distance of separation narrower than the critical dimension provided by the photoresist layer can be produced.

Unlike a conventional conductive pattern fabrication process that makes use of spacers, the invention can be applied on devices having great step height. There is no need to worry about the formation of unwanted spacers at step height transition regions leading to residual conductive layer and causing possible bridging between devices.

Furthermore, all the processing steps from using the photoresist layer as a mask to form the second mask layer with a trapezium-shaped profile to etching the conductive layer to form a conductive line pattern can be conducted in the same reaction chamber inside an etching station. There is no need to transfer the wafer from an etching chamber to a deposition chamber and vice versa. Since the conductive line pattern can be formed in-situ, fabrication steps are very much simplified.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A photolithographic and etching method, comprising the steps of:
providing a substrate having a conductive layer thereon;
forming a first mask layer over the conductive layer;
forming a second mask layer over the first mask layer;
forming a patterned photoresist layer over the second mask layer;
performing a slant anisotropic etching using the photoresist layer as a mask to remove a portion of the second mask layer until the first mask layer is exposed, so that a remaining portion of second mask layer has a bottom which connects to the first mask layer, and the bottom is wider than a top of the second mask layer;
removing the exposed first mask layer using the second mask layer as a mask;
removing the photoresist layer;
removing the exposed conductive layer using the first mask layer as a mask to form a conductive line pattern over the substrate;
removing the second mask layer; and
removing the first mask layer.

2. The method of claim 1, wherein the step of performing the slant anisotropic etching includes using a gaseous etchant that contains carbon.

3. The method of claim 1, wherein the step of forming the first mask layer includes chemical vapor deposition.

4. The method of claim 1, wherein the step of forming the first mask layer includes depositing silicon nitride.

5. The method of claim 1, wherein the step of forming the second mask layer includes chemical vapor deposition.

6. The method of claim 1, wherein the step of forming the second mask layer includes depositing polysilicon.

7. The method of claim 1, wherein material forming the conductive layer includes polysilicon.

8. The method of claim 1, wherein the second mask layer and the exposed conductive layer are removed concurrently.

9. The method of claim 1, wherein the step of removing the first mask layer includes isotropic etching.

10. A photolithographic and etching method, comprising the steps of:
providing a substrate having a conductive layer thereon;
forming a patterned first mask layer over the conductive layer;
forming a patterned second mask layer on the first mask layer, wherein the patterned second mask layer has a bottom connected to the first mask layer, and the bottom of the second mask is wider than a top of the second mask layer;
removing the exposed first mask layer with the patterned second mask layer serving as a mask;
removing the exposed conductive layer using the first mask as a mask so that a conductive pattern is formed over the substrate;
removing the second mask layer; and
removing the first mask layer.

11. The method of claim 10, wherein the step of forming the patterned second mask layer includes the sub-steps of:
forming a blanket mask layer on the first mask layer;
forming a patterned photoresist layer over the blanket mask layer; and
performing a slant anisotropic etching using the photoresist layer as a mask to remove a portion of the blanket mask layer until the first mask layer is exposed, so that a patterned second mask layer is formed.

12. The method of claim 11, wherein the step of performing the slant anisotropic etching includes using a gaseous etchant that contains carbon.

13. The method of claim 11, wherein the step of forming the first mask layer includes chemical vapor deposition.

14. The method of claim 11, wherein the step of forming the second mask layer includes chemical vapor deposition.

15. The method of claim 10, wherein the step of forming the first mask layer includes depositing silicon nitride.

16. The method of claim 10, wherein the step of forming the second mask layer includes depositing polysilicon.

17. The method of claim 10, wherein material forming the conductive layer includes polysilicon.

18. The method of claim 10, wherein the second mask layer and the exposed conductive layer are removed concurrently.

19. The method of claim 10, wherein the step of removing the first mask layer includes isotropic etching.

20. The method of claim 10, wherein the conductive pattern includes a conductive line pattern.
